(19) United States
(12) Patent Application Publication
(10) Pub. No.: US 2006/0186733 A1
(43) Pub. Date: Aug. 24, 2006

(54) Electrohydraulic brake system for motor vehicles

(75) Inventor: Stefan A. Drumm, Saulheim (DE)

Correspondence Address: CONTINENTAL TEVES, INC., ONE CONTINENTAL DRIVE, AUBURN HILLLS, MI, 48326-1581, US

(73) Assignee: Continal Teves AG & Co. oHG

(21) Appl. No.: 10/564,334

(22) PCT Filed: Jul. 12, 2004
(86) PCT No.: PCT/EP04/51466

§ 371 Date: Jan. 11, 2006

(30) Foreign Application Priority Data
Jul. 11, 2003 (DE) 103 31 784.8
Oct. 8, 2003 (DE) 10346 674.6

(51) Int. Cl. B60T 8/44

(52) U.S. Cl. 303/114.1

(57) ABSTRACT

Disclosed is a brake system which can be operated in three modes of operation, a non-boosted mode of operation, a hydraulic-booster mode of operation, and an electronically controlled mode of operation. The brake system includes a master cylinder (1), a first piston (2) coupled to a brake pedal (3), a second piston (4) actuating the master cylinder (1), and a third piston (5) actuatable by the first piston (2), with at least one elastic element (6, 7) being provided between the first and the third piston (5), and all three pistons (2, 4, 5) are arranged in a housing (8). Further, there is provision of a hydraulic pressure source (9) and a valve device (10) for reducing the pressure of the pressure source (9) to a value of pressure that is fed into a space (11) by which the second piston (4) and the third piston (5) are separated from each other in such a fashion that the third piston (5) is acted upon by the pressure acting upon the second piston (4) in the direction being opposite to the direction of application of the second piston (4). A device (29-31, 45) which, by way of a variation of the pressure fluid volume in the hydraulic chamber (21) controlled by electromagnetic valve, allows a pedal performance which differs from the brake pedal characteristics that is predefined by the brake pedal characteristics simulation device.

### BACKGROUND OF THE INVENTION

The present invention relates to a brake system for motor vehicles that can be operated in a ‘brake-by-wire’ mode of operation, comprising: a master cylinder to which wheel brake cylinders can be connected, a first piston which is coupled to a brake pedal, a second piston which actuates the master cylinder, a third piston which can be operated by the first piston, with at least one brake pedal characteristics simulation device being provided that imparts a comfortable pedal feel to the operator in a by-wire mode of operation, and all three pistons and the brake pedal characteristics simulation device are arranged in a housing, with a hydraulic pressure source and a valve device for reducing the pressure of the pressure source to a value that is used for application of the second piston, and the second and the third piston are isolated from each other by a space in such a fashion that the third piston is acted upon by the pressure that acts on the second piston in the direction opposite to the direction of application of the second piston.

Brake-by-wire systems are being used at an increasing rate in motor vehicle technology. The brake in these brake systems can be actuated independently by way of electronic signals without any action on the driver's part. These electronic signals may e.g. be output from an electronic stability program ESP or a collision avoidance system ACC. When an independent actuation is superposed on an actuation by the driver, the driver of the motor vehicle feels a reaction in the brake pedal in the way of a deviation from the customary pedal characteristics. This reactive effect on the brake pedal can be unusual or unpleasant to the driver, on the one hand, so that the driver will not apply the brake pedal in a critical situation of traffic as intensely as would be necessary in this situation because he/she is irritated by the reaction which the independent actuation of the brake produces at the brake pedal. On the other hand, the driver receives a haptic feedback by brake pedal vibrations in ABS and ESP control activities. It would be desirable to completely avoid disturbances of the brake pedal characteristics and to obtain electronically controllable pedal vibrations which are reduced compared to prior art conventional brake systems.

EP 1 078 833 A1 describes an electrohydraulic brake system of the type mentioned hereinabove. The special arrangement of the pistons achieves an uncoupling of the brake pedal from the mentioned hydraulic components so that the above-mentioned reactive effect can be eliminated to a greatest possible extent. It is disadvantageous in the brake system known in the art that the brake pedal characteristics in the ‘brake-by-wire’ mode of operation is invariably predefined by the properties of the passive elastic and damping elements which form the brake pedal characteristics simulation device and does not allow a haptic feedback from the brake system to the driver's foot.

### SUMMARY OF THE INVENTION

In view of the above, an object of the invention is to provide a brake system of the type referred to hereinabove in which an active intervention into the brake pedal characteristics simulation device is possible in the sense of the haptic feedback referred to hereinabove. Another objective is that the brake system has a simple design and allows manufacture at low costs.

According to the invention, this object is achieved in that there is provision of a device which, by way of a valve-controlled variation of the pressure fluid volume in the hydraulic chamber, allows an electronically controllable pedal performance that differs from the brake pedal characteristics that is predefined by the brake pedal characteristics simulation device. In this arrangement, the device is preferably controllable by the electric control and regulation unit.

To render the idea of the invention more precise, it is arranged for in a favorable improvement of the object of the invention that the electrically controllable device is formed of a first electromagnetically operable two-way/two-position directional control valve inserted into a first connection between the hydraulic chamber and an unpressurized pressure fluid supply reservoir, a second electromagnetically operable two-way/two-position directional control valve inserted into a second connection between the hydraulic chamber and an unpressurized pressure fluid supply reservoir, as well as a third electromagnetically operable two-way/two-position directional control valve inserted into a conduit leading to the pressure source.

### BRIEF DESCRIPTION OF THE DRAWINGS

The invention will be explained in detail in the following using an embodiment by making reference to the accompanying schematic drawings. In the drawings:

FIG. 1 shows the design of the brake system of the invention in the rest condition according to a first embodiment;

FIG. 2 shows an alternative embodiment of a brake pedal characteristics simulation device which can be employed in the brake system according to FIG. 1.

### DETAILED DESCRIPTION OF THE DRAWINGS

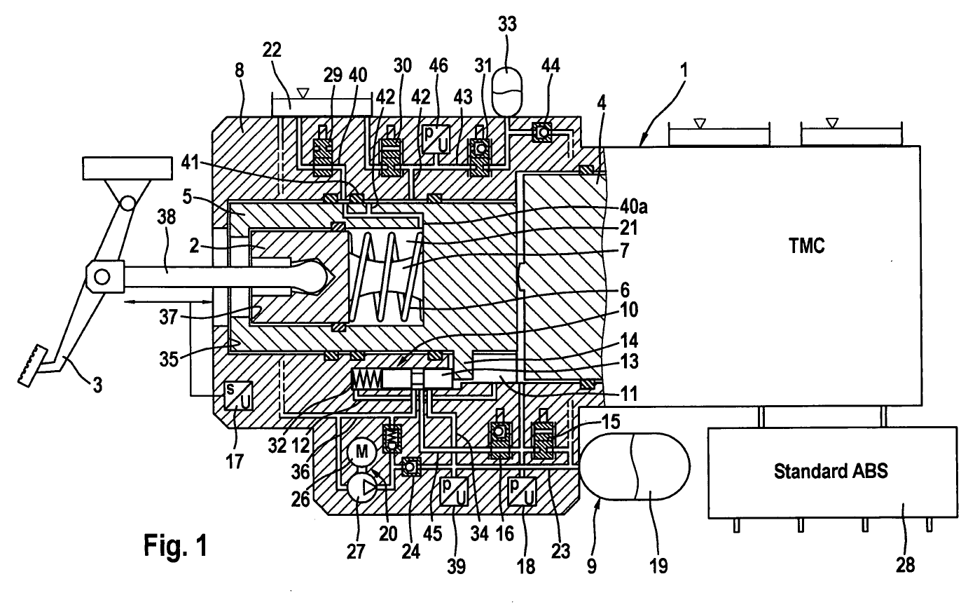

FIG. 1 shows the brake system of the invention in the rest condition. The brake system includes a brake pedal 3 which is rigidly connected to a first piston 2 by way of an actuating rod 38. The brake pedal travel can be sensed by means of a travel sensor 17. The first piston 2 is arranged in a third piston 5, and a hydraulic chamber 21 is arranged between the first and the third piston in which elastic elements 6, 7 are arranged which apply forces to the first and third pistons and, along with non-illustrated damping and/or friction elements, form a brake pedal characteristics simulation device that brings about a simulator force between the first (2) and the third piston 5.

Further, a second piston 4 is provided which is associated with a master cylinder 1 and permits pressure buildup therein. The master cylinder 1 is connected to wheel brakes (not shown) of the vehicle by way of an electrohydraulic control or regulation unit 28 (only represented) of an anti-lock system (ABS).

The first (2), the second (4) and the third piston 5 are accommodated in a housing 8. A space 11 which can be filled with pressure fluid is interposed between the third piston 5 and the second piston 4.

When applying the brake pedal 3, the driver moves the first piston 2 in opposition to the simulator force which is produced by the brake pedal characteristics simulation device. The passive elastic (6, 7) and frictional or damping elements comprised in the brake pedal characteristics simulation device are so configured that they impart to the driver the brake feel which corresponds to a customary brake pedal characteristics. This means that with a short brake pedal travel, the pedal force initially jumps to a starting value, rises slowly with a long pedal travel, while it grows over-proportionally with a longer brake pedal travel.

By applying the brake pedal, the pressure in the space 11 is controlled in a hydraulically controlled mode of operation by means of a first valve device in such a fashion that the third piston 5 remains directly adjacent to a stop 35 in the housing 8, and it is controlled in a preferred ‘by-wire’ mode of operation by means of a second valve device in such a fashion that the third piston 5 remains in abutment on stop 35 in the housing 8. The ‘by-wire’ mode of operation comprises brake operations initiated by the driver by way of depression of the brake pedal, as well as autonomous brake operations, i.e. electronically controlled brake operations and initiated without action on the part of the driver, and their superpositions. In the first-mentioned mode of operation, pedal movement and pedal force are largely uncoupled from the actuating condition of the master cylinder 1, while they are completely uncoupled therefrom in the second mode of operation. Pressure pulsations in the master cylinder 1 which occur in ABS and ESP control operations cannot propagate to the brake pedal due to this uncoupling, which is in contrast to conventional brake system.

In the hydraulically controlled mode of operation, application of the brake pedal 3 and the related buildup of a simulator force allow the third piston 5 to be moved in the direction of the second piston 4, with the result that a valve device 10 is actuated already after a very short displacement travel. The valve device 10 in the illustrated example is configured as a hydro-mechanical booster valve which includes a valve member 13 that is preloaded by means of a spring 32 in the direction of the second piston 4 and includes two control edges, whose purpose will be explained in the following text. A hydraulic connection 12 allows the application of the pressure introduced into the space 11 to the end surface of the valve member 13 remote from the space 11. In this arrangement, the valve member 13 interacts with an actuating element which is configured as a radial projection 14 shaped at the third piston 5 in the embodiment shown. When the third piston 5 moves slightly in the direction of the second piston 4, the valve member 13 will follows its movement until a connection is established between the space 11 and a hydraulic pressure source 9. This connection is established in that the right-hand control edge of the valve member 13 as shown in the drawing opens the flow path between a hydraulic pressure conduit 23 leading from the pressure source 9 or a conduit portion 33 branching therefrom and a pressure fluid channel 34 opening into the space 11. The hydraulic pressure source 9 is preferably formed of a high-pressure accumulator 19 being charged by a motor-and-pump assembly 20. The motor-and-pump assembly 20 comprises an electric motor 26 and a hydraulic pump 27 whose suction side is connected to an unpressurized pressure-fluid supply reservoir 22, while its pressure side is in connection to the high-pressure accumulator 19 through the above-mentioned conduit 23. Inserted into conduit 23 is a non-return valve 24 that opens towards the high-pressure accumulator 19, and a pressure sensor 39 allows monitoring the charging condition of the high-pressure accumulator 19. The high-pressure accumulator 19 supports the pump 27 mainly in those cases in which pressure build-up is required in a short time, for example in the case of quick emergency braking, which pressure cannot be provided instantaneously by the pump 27 due to its mass inertia. By means of the connection between the high-pressure accumulator 19 and the space 11, the latter is acted upon by pressure, with the result that the second piston 4 in the master cylinder 1 builds up pressure and the third piston 5 is urged in the direction of a stop 35 in the housing 8, on which it abutted before the brake was applied. A valve 15 connected to the high-pressure accumulator 19, a pressure increase valve, is closed in the de-energized condition, while a separating valve 16 inserted into the pressure fluid channel 34, i.e. a separating valve in the illustrated embodiment, is open in the de-energized condition so that the pump 27 or the high-pressure accumulator 19 can apply pressure to the space 11 by way of the connection explained hereinabove. A pressure sensor 18 can sense the pressure introduced into the space 11. Energization of the separating valve 16 allows precluding the discharge of pressure fluid out of the space 11 through the valve device 10, while pressure fluid can be introduced into the space 11 by way of energization of the pressure increase valve 15.

In the non-applied condition of the brake pedal 3, the first piston 2 is urged against a stop 37 by way of the elastic elements 6 and 7, said stop being provided in the third piston 5. The elastic elements 6, 7 which form the above-mentioned brake pedal characteristics simulation device in the example shown are arranged in a hydraulic chamber 21 limited by the first (2) and third piston 5, said chamber being connectible to the pressure fluid supply reservoir 22, on the one hand, and to the pressure source 9 or the high-pressure accumulator 19, on the other hand. Inserted into the first connection 40 between the hydraulic chamber 21 and the pressure fluid supply reservoir 22, which can be closed by a relative movement of the third piston 5 in relation to the housing 8, is an electromagnetically operable, preferably normally open (NO) two-way/two-position directional control valve 29, and the hydraulic chamber 21 is closed because the port of the connecting portion 40a designed in the third piston 5 will override a seal 41 immovably arranged in the housing 8. Inserted into the second connection 42 between the hydraulic chamber 21 and the pressure fluid supply reservoir 22, which is connected to the connecting portion 40a in the actuating direction of the pistons 2, 5 behind the seal 41, is a second electromagnetically operable, preferably normally closed (NC) two-way/two-position directional control valve 30, to the inlet port of which another hydraulic conduit 43 is additionally connected that leads to the pressure source 9 or the high-pressure accumulator 19. In conduit 43, a third electromagnetically operable, preferably normally closed (NC) two-way/two-position directional control valve 31 and a non-return valve 44 closing towards the high-pressure accumulator 19 are inserted, and an additional pressure sensor 32 is connected which is used to determine the pressure that prevails in the hydraulic chamber 21. Besides, a second (auxiliary) high-pressure accumulator 33 can be connected to the conduit 43. The third two-way/two-position directional control valve 31 closes the hydraulic conduit 43 in its first switch position, while it fulfils the function of a non-return valve that closes towards the high-pressure accumulator 19 in a second switch position. The above-mentioned two-way/two-position directional control valves 29, 30, and 31 form an electrically controllable device which permits a variation of the pressure fluid volume in the hydraulic chamber 21 and, hence, allows an electronically controllable pedal performance which differs from the brake pedal characteristics that is predefined by the brake pedal characteristics simulation device in the ‘brake-by-wire’ mode of operation.

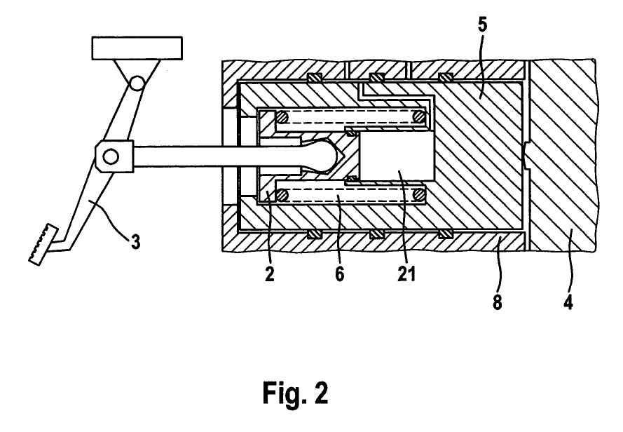

FIG. 2 shows an alternative design of the brake pedal characteristics simulation device where the elastic element or the compression spring 6 is arranged outside the hydraulic chamber 21 and, thus, remains ‘dry’.

The described brake system of the invention, by making reference to the accompanying drawings, may, of course, also be operated in other modes of operation. Thus, in a mode of operation which is characterized by a brake operation independent of the driver's request, actuation of the second valve device causes the actuating pressure in the space 11 to be adapted to a nominal pressure value with is continuously re-calculated. To this end, energization of the separating valve 16 permits interrupting the volume flow to the valve device 10, while the possibility of the reverse volume flow from the first valve device 10 through the separating valve 16 for pressure increase in the space 11 is maintained. An actuating pressure being higher than the pressure which would be predetermined by the hydro-mechanical booster valve, i.e. valve device 10, can be adjusted in an electronically controlled fashion by way of the pressure increase valve 15. The energization of the separating valve 16 is temporarily discontinued for the purpose of electronically controlled pressure reduction, so that pressure fluid can discharge to the valve device 10 which establishes a connection to the pressure fluid supply reservoir 22 in this operating state. This connection is established because the control edge of the valve member 13 being on the left-hand side in the drawing opens the flow path between the pressure fluid channel 44 and a hydraulic connection 36 leading from the valve device 10 to the pressure fluid supply reservoir 22. This electronic brake pressure control is advantageous because its transmission performance can be freely selected within the limits of the dynamics given by the technical data of high-pressure accumulator, pressure increase valve and separating valve. Therefore, a so-called jump function, i.e. jumping to a predetermined brake pressure value when touching the brake pedal 3, a brake assist function, a deceleration control and an autonomous brake operation, as it is required e.g. for TCS (Traction Slip Control), ESP (Electronic Stability Program) and ACC (Adaptive Cruise Control), can be realized by software measures. To this end, the driver's specification in the form of a brake pedal application which is sensed by travel sensors, force sensors, or other types of sensors, is converted into wheel brake pressures by a calculating unit (not shown) by using appropriate algorithms, the latter pressures being realized by means of the electronically controllable valves in the independent force braking module and the subsequent ABS hydraulic unit.

In the above-mentioned, preferred ‘brake-by-wire’ mode of operation, which is characterized by an independent brake operation initiated by the driver's deceleration request, hydraulic pressure is controlled in the space 11 by a corresponding actuation of the valves 15, 16 by means of the electronic control and regulation unit not shown in response to the signal of the travel sensor 18 sensing the driver's request. This pressure is always rated such that it is sufficient to retain the third piston 5 on its stop 35 in housing 8. The results is a brake pedal characteristics, i.e. a correlation between brake pedal force, brake pedal travel and brake pedal speed which can be described by mathematical functions, in which the actuating condition of the master cylinder 1 is not included. The essential parameters of the brake pedal characteristics are the rigidities and preloads of the elastic elements 6 and 7. A haptic feedback by way of the driver pedal can be achieved by means of an electronically controlled deviation from the brake pedal characteristics predefined by passive elements. To this end, electrically controllable valves 29, 30, 31 are used to control the pressure fluid volume in the hydraulic chamber 21, while the otherwise open hydraulic connection 40 between the hydraulic chamber 21 and the supply reservoir 22 is closed. The connection 40 is simply opened again in order to terminate a phase of operation of the brake system with a differing brake pedal characteristics. The valve switching operations for the superposition of the predefined brake pedal characteristics (Force Feedback Pedal) will be described in more detail in the following text.

To push back the brake pedal 3, initially the first connection 40 between the hydraulic chamber 21 and the pressure fluid supply reservoir 22 is closed by change-over of the two-way/two-position directional control valve 29. Subsequently, hydraulic pressure is applied to the chamber 21 by controlled opening of the third two-way/two-position directional control valve 31, with the result that additional pressure fluid flows into the chamber 21 and the pedal 3 is pushed back. Monitoring the pressure in the chamber 21 by means of the pressure sensor 32 and the brake pedal movement by means of the travel sensor 17 allows sensing the driver's request in spite of the additional resetting force. For an active reduction of the additional pressure fluid volume introduced into chamber 21, the first two-way/two-position directional control valve 29 is maintained closed and the pressure fluid volume is discharged into the pressure fluid supply reservoir 22 by opening the second two-way/two-position directional control valve 30. The above-mentioned seal 41 which can be overridden by the port of the connecting portion 40a is protected because the valve 29 is maintained closed. When the additional resetting force is no longer required, the hydraulic chamber 21 is rendered unpressurized again by opening the first two-way/two-position directional control valve 29, after complete discharge of the additional pressure fluid volume through the second two-way/two-position directional control valve 30.

In a third mode of operation which is characterized by failure of the electric current supply or the so-called hydraulic fallback mode, the electromagnetic valves 15 and 16 remain de-energized. This enables the valve device 10, i.e. the hydro-mechanical booster valve, to control the actuating pressure in the space 11 and, thus, bring about brake force boosting. As this occurs, pressure increase is controlled by the interaction between the control edge of the valve member 13 which is on the right-hand side of the drawing and the conduit portion 34, while pressure reduction is controlled by the interaction between the control edge that is on the left-hand side in the drawing and the hydraulic conduit 36. Hydraulic boosting functions without electricity as long as the high-pressure accumulator 19 can supply pressurized pressure fluid. There is a linear power boosting, the boosting factor of which is invariably predetermined by the ratio between the cross-sectional surfaces of second piston 4 and third piston 5.

In a fourth mode of operation which is characterized by the lack of hydraulic pressure in the pressure accumulator 19 or the so-called mechanical fallback mode, the brake system can be operated in a purely mechanically fashion, the third piston 5 moves under the effect of an actuating force introduced at the brake pedal 3 away from its stop 35 and displaces the second piston 4 by way of mechanical force transmission so that the actuation of the master cylinder 1 takes place exclusively by muscular power. The relative movement of the third piston 5 that takes place with respect to the housing 8 causes closing of the above-mentioned hydraulic chamber 21 because the port of a conduit 40 connected to the hydraulic chamber 21 overrides a stationary seal 41 arranged in the housing 8. This closure enables deactivation of the function of the brake pedal characteristics simulation device 6, 7 so that a direct force transmission takes place from the first (2) to the third piston 5.

The pedal performance differing from the predetermined brake pedal characteristics allows providing the driver with a haptic feedback concerning the operating condition of the brake control system by way of electronically controlled pedal vibrations. The information about frequency and intensity of the vibration can be quantified. Further, an electronically controlled, temporary push back of the brake pedal will give the driver feedback as to when an ABS or ESP control is carried out. Preferably, these intentional feedback operations can be reduced in their intensity as compared to the inevitably strong and frequently disturbing or irritating pedal reactions which are induced by the principle of conventional brake systems.

1-15. (canceled)

16. An electrohydraulic brake system for a motor vehicle which can be operated in a ‘brake-by-wire’ mode of operation both by an operator and independently of the operator, the brake system comprising:
a master cylinder (1) connectable to wheel brake cylinders;
a first piston (2) coupled to a brake pedal (3);
a second piston (4) for actuating the master cylinder (1);
a third piston (5) which can be operated by the first piston (2);
at least one brake pedal characteristics simulation device (6, 7) provided between the first (2) and the third piston (5) for imparting a comfortable pedal feel to the operator in a ‘brake-by-wire’ mode of operation;
a hydraulic chamber (21) cooperating with the brake pedal characteristics simulation device (6, 7) being limited between the first (2) and the third piston (5), wherein all three pistons (2, 4, 5) and the brake pedal characteristics simulation device (6, 7) are arranged in a housing (8);
a hydraulic pressure source (9) operable by an electronic control and regulation unit;
a valve device (10) operable by the third piston (5) for reducing the pressure of the pressure source (9) to a value used for application of the second piston (4), wherein the second (4) and the third piston (5) are isolated from each other by a space (11) so that the third piston (5) is acted upon by the pressure that acts on the second piston (4) in a direction opposite to a direction of application of the second piston (4); and
a device (29-31, 45) which by way of a variation of the pressure fluid volume in the hydraulic chamber (21) controlled by electromagnetic valve, allows a pedal performance that differs from a brake pedal characteristics that is predefined by the brake pedal characteristics simulation device.

17. A brake system according to claim 16, wherein the device (29-31) is electrically controllable by the electric control and regulation unit.

18. A brake system according to claim 17, wherein the device is formed of an electromagnetically operable two-way/two-position directional control valve (29) inserted into a first connection (40) between the hydraulic chamber (21) and an unpressurized pressure fluid supply reservoir (22), a second electromagnetically operable two-way/two-position directional control valve (30) inserted into a second connection (42) between the hydraulic chamber (21) and the unpressurized pressure fluid supply reservoir (22), as well as a third electromagnetically operable two-way/two-position directional control valve (31) inserted into a conduit (43) leading to the pressure source (9 or 19).

19. A brake system according to claim 18, wherein a pressure sensor (32) is provided to determine the pressure prevailing in the hydraulic chamber (21).

20. A brake system according to claim 18, wherein the first two-way/two-position directional control valve (29) is configured as a normally open (NO) valve, while the second two-way/two-position directional control valve (30) is configured as a normally closed (NC) valve.

21. A brake system according to claim 18, wherein the third two-way/two-position directional control valve (31) is configured as a normally closed (NC) valve which closes the hydraulic conduit (43) in its first switch position and fulfils the function of a non-return valve closing towards the pressure source (9, or 19) in its second switch position.

22. A brake system according to claim 16, wherein a sensor (39) is provided to monitor a charging condition of the high-pressure accumulator (19), whose output signal is sent to the electronic control unit and which is integrated in the housing (8) or form-lockingly connected to the housing.

23. A brake system according to claim 16, wherein a pressure sensor (18) is provided to sense the pressure that prevails in the space (11), whose output signal is sent to the electronic control unit and which is integrated in the housing (8) or form-lockingly connected to the housing.

24. A brake system according to claim 16, wherein an electrohydraulic control or regulation unit (28) of an anti-lock system (ABS) is connected to the master brake cylinder (1).

25. A brake system according to claim 16, wherein the brake pedal characteristics simulation device comprises at least one elastic element (6, 7) which exerts a ‘spring force’ component of the force generated by the brake pedal characteristics simulation device which depends on the relative travel between first (2) and third piston (5).

26. A brake system according to claim 25, wherein the brake pedal characteristics simulation device comprises at least one damping device which exerts a ‘damping force’ component of the force generated by the brake pedal characteristics simulation device that depends on the relative speed between the first (2) and the third piston (5).

27. A brake system according to claim 25, wherein the brake pedal characteristics simulation device (6, 7) comprises at least one of the components steel spring, elastomeric body, and frictional connection exerting the force generated by the brake pedal characteristics simulation device.

28. A brake system according to claim 27, wherein each of the components exerting the force generated by the brake pedal characteristics simulation device are arranged either outside (‘dry’) or inside (‘wet’) the hydraulic chamber (21).

29. A brake system according to claim 16, wherein the pedal performance differing from the predetermined brake pedal characteristics includes electronically controlled pedal vibrations.

30. A brake system according to claim 16, wherein the pedal performance differing from the predetermined brake pedal characteristics includes an electronically controlled temporary push back of the brake pedal.
